(19) United States
(12) Patent Application Publication
(10) Pub. No.: US 2017/0140305 A1
(43) Pub. Date: May 18, 2017

(54) Designer Outings

(71) Applicant: Austin T. Moss, El Sobrante, CA (US)

(72) Inventor: Austin T. Moss, El Sobrante, CA (US)

(21) Appl. No.: 14/939,024

(22) Filed: Nov. 12, 2015

(51) Int. Cl. G06Q 10/02; G06Q 50/00; H04L 12/58; G06Q 30/02; H04L 29/06; H04L 29/08

(52) U.S. Cl. CPC G06Q 10/02; H04L 67/42; H04L 67/306; H04L 51/32; G06Q 30/0282; G06Q 50/01

(57) ABSTRACT

Disclosed herein is a method for facilitating promotion of personal or commercial travel itinerary using social computing based environment wherein the a central server is connected to a plurality of user devices over a network. In one embodiment of the invention, this method may be implemented to enable a person to create a travel plan to visit different places, purchase a various travel packages to visit different places and post their purchases on a social networking profile. Further the method may be implemented to enable a person to find, contact and communicate with people all over the world either to recommend or advertise or sale different purchased deals.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The disclosure generally relates to the field of sales, marketing, and advertising and, more specifically, the present invention relates to providing recommendations related to offerings available for purchase via an online site and for distributing of purchase commissions among distributors and users.

(2) Background

The interconnectivity of individuals and organizations has increased exponentially in recent times with advent of various telecommunication means, including the Internet. The Internet has connected the world with literally billions of connected nodes (or users) representing entities of various types,—people, organizations, computers, and other devices. Many solutions such as the World Wide Web, online bulletin boards, email, online instant messaging, and peer-to-peer solutions allow direct contact between any number of these nodes. The very success of this inter-node connectivity/accessibility has however lead to further problems where a node/entity would prefer to control its ‘visibility’ and accessibility to a subset of the potential world-wide internet community, for any number of reasons, e.g. discretion, trust, association, preference, improving the quality and relevance of information and so forth.

Time and resources are wasted in the marketing of online products and services. Consumers waste time shopping in person or attempting to search for products or services online where they lack control or create suitable preferences for access to the search results. One approach taken in response to these and other shortcomings involves providing for products or services over the Internet, e.g., a system for shopping online over public computer networks such as the Internet. However, users and members of such systems stem usually must be registered, wherein registration and/or subscription by the user can provide information sufficient to identify the user, such as the users and members name, address, Internet e-mail address, and/or an identification number, using an Internet server and a user display terminal in communication therewith. There are, however, numerous shortcomings to such a system. Group buying sites leverage the power of collective bargaining, providing local product or services deals that offer savings for consumers while delivering improved sales numbers to participating merchants.

Buying travel products is a complicated decision that comes with higher purchasing risks for buyers than the purchase of other products. Unlike other products, travel purchases may not be tested or experienced before use and the products may not be returned or exchanged for other products if the products did not deliver the expected experience or performance. Buyers therefore rely heavily on recommendations of “experts” like travel agents, guidebooks or the Internet. However, these “experts” almost never know all the travel preferences of the user and have no reasonable means to compare the preferences and past travel experiences of the buyer with those of other users. Thus, there remains a need for a system that may provide more accurate and higher quality travel recommendations. However, there are problems and shortcomings with online products or services which should also provide socially conscious information about the companies that supply the online products or services so that consumers can see where the companies and/or stores are located and can find out information about the companies, communities they are located in, what interaction and help they provide to communities and/or other economic and/or socially responsible activities, and to associate the geographical and other geospatially available information connecting also by the use of integrated social media, which combination is not current provided and/or available.

Consumers enjoy interacting with friends, acquaintances and strangers across many media channels, but that doesn't mean they trust them as a source of advertising. However, a new host of companies are connecting brands to consumers through their social connections. New web technology has created unexpected ways for advertisers to track your web activity without your knowledge enabling advertising networks to secretly monitor a user's activity across multiple websites and build detailed profiles of their behavior and interests.

### BRIEF SUMMARY OF THE INVENTION

The primary objective of the invention is to provide a method for facilitating promotion of personal or commercial travel itinerary using social computing based environment wherein the a central server is connected to a plurality of user devices over a network.

In one embodiment of the invention, this method may be implemented to enable a person to create a travel plan to visit different places, purchase a various travel packages to visit different places and post their purchases on a social networking profile.

In a preferred embodiment of the invention, the method may be implemented to enable a person to find, contact and communicate with people all over the world either to recommend or advertise or sale different purchased deals.

In another embodiment of the invention, a social computing based means is implemented that enables its users to connect with other users for the aforementioned purpose. The social computing based means can be accessed and used from a user's communication device using an internet connection.

Further in another embodiment of the invention, the method implements a Graphical User Interface operable with the means for control and navigation of the user's communication device that enables the user to use the various means provided through the social computing based means to perform actions related to recommend or advertise or sale different purchased deals. Furthermore, upon registering with the social computing based means, a user may decide to either use or render services provided by other users registered with the social computing based means, or use and render services simultaneously. The social computing based means enables a user to act either as a user who provides services to other users, or act as an end user to use services provided by other users, or act as all simultaneously. In the method, through the social computing based means, a means is provided to the user to create a user account and the user account enables access to the social computing based means. A means is provided to the user to provide information associated with the user and to interact and communicate with the other users having accounts associated with the social computing based means. Information provided by the user through his/her user account may be presented on a profile associated with the user account. The profile maybe viewed by the other users having accounts associated with the social computing based means. The method involves providing, through the social computing based means, a means to the user to add at least one profile video to be viewed by the other users having accounts associated with the social computing based means.

The summary is provided to introduce a selection of concepts in a simplified form that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The drawings constitute a part of this specification, and include exemplary embodiments to the invention, which may be embodied in various forms. It is to be understood that, in some instances, various aspects of the invention may be shown exaggerated or enlarged to facilitate an understanding of the invention.

FIG. 1 illustrates a prospective view of the invention identifying the different components of the invention and their working.

FIG. 2 illustrates a prospective view of the arrangement of the items in the GUI used in the invention.

FIG. 3 illustrates a prospective view of the interface used in the invention.

### DETAILED DESCRIPTIONS OF THE INVENTION

According to the invention disclosed herein the method for facilitating promotion of personal or commercial travel itinerary using social computing based environment wherein the a central server is connected to a plurality of user devices 1 over a network, however the method comprises of receiving, using one or more computing devices 1, information about the travel itinerary of at least one user, wherein the information comprises a name, at least one travel destination, and a travel plan of the user; providing, through a social computing based means, a means to a user to create a user account, wherein the user account enables the user to access the social computing based means; registering at least one user profile by receiving in a database of the central server, with the information provided by the new user at the server; generating at least one user profile for the registered user of the social computing based network, in connection with the user registration; providing, through the social computing based means, a means to the user to provide information associated with the user, communicate and interact with other users having accounts associated with the social computing based means; providing, through the social computing based means, a means to the user to add at least one travel itinerary to be viewed by the other users having accounts associated with the social computing based means; providing, through the social computing based means, a means to the user to post at least one information item relating to the travel itinerary over the social computing based network; providing, through the social computing based means, a means to the user to link various other social networking profiles to the user profile of the social computing based network; providing, through the social computing based means, a means to the user to view at least one news item posted by the other users; providing, through the social computing based means, a recommending mechanism means to facilitate recommendation between the user and the other users; providing, through the social computing based means, a payment mechanism means to facilitate monetary transactions between the user and the other users; providing, through the social computing based means, a means to the end user for viewing information about the at least one travel itinerary recommended by the user. For example, a user can promote their vacation via social network media and retain part of the commission in their profile “Virtual wallet”, they made when they sign up to my website. They can use the funds they generate in their wallet for future travel or simply re-deposit it in their bank account to supplement their vacation cost. Also this can be great for any travel, let's say if a bride and groom and design their destination wedding itinerary and send it out to all the guess of their wedding that are going to attend via email, Facebook, twitter invitation (Which under my website will be a, “Private Event”. Everyone from the wedding books their travel through the invitations and gets discounts via commission split. Everyone's profile will track their current and past vacations, and have a layout on how much commission they will get if they sign up.

According to the invention, the method, through the social computing based means, a means is provided to the user to create a user account and the user account enables access to the social computing based means, a means is provided to the user to provide information associated with the user and to interact and communicate with other users having accounts associated with the social computing based means.

In the method, through the social computing based means, a means is provided to the user to create a user account and the user account enables access to the social computing based means. A means is provided to the user to provide information associated with the user and to interact and communicate with other users having accounts associated with the social computing based means.

The means for creation of a user account may facilitate the user to input various information like (but not limited to) personal information, financial information and purpose of use. This may be achieved using various means like electronic forms to be filled by the user or interactively asking questions or through any other means for collecting information from the user.

Information provided by the user through his/her user account may be presented on a profile associated with the user account. The profile maybe viewed by other users having accounts associated with the social computing based means.

Information provided by the user through the social computing based means may be received and processed by a server and stored in one or more databases associated with the server.

Furthermore the connectivity of these devices 1 can use a plurality of communication standards, protocols and technologies and any other suitable communication protocol, including communication protocols not yet developed as of the filing date of this document. The present invention maybe implemented on applications that run on a single or variety of operating system platforms or embedded operating systems.

Furthermore, the present invention may also be implemented to work with various web browsers including but not limited to Internet Explorer, Mozilla Firefox, Safari and Opera that access and handle various types of web pages constructed with various markup languages such as HTML, HTML-5, XHTML, XML, etc. and the associated CSS (cascading style sheet) files and java-script files.

Also, the social computing based means may be realized using (but not limited to) one or more servers, one or more database and networks associated with the servers and one or more software modules running on the servers.

The social computing based means may be accessed and used from the communication devices 1 of the users of the social computing based means as an application software or a website that runs/executes on these the communication devices 1. The application software or the website exchange data with the servers over an internet connection.

The method implements a Graphical User Interface 3 operable with the means for control and navigation of the user's communication device 1 that enables the user to use the various means provided through the social computing based means to perform actions related to making remote purchases and/or shipping and/or storage and/or delivery of items, or render services for the same. However, other User Interfaces 3 may also be implemented.

The various hardware platforms on which the applications that implement the present invention run may use one or more processors with different instruction-sets, architectures, clock-speeds, etc. and memory may include high speed random access memory and non-volatile memory such as one or more magnetic disk storage devices 1, flash memory devices 1 and other kinds of solid state memory devices 1.

Display means used by these hardware platforms may use LCD (liquid crystal display) technology, LED (light Emitting Diode) technology, CRT (Cathode ray tube) technology, or LPD (light emitting polymer) technology or any other display technologies.

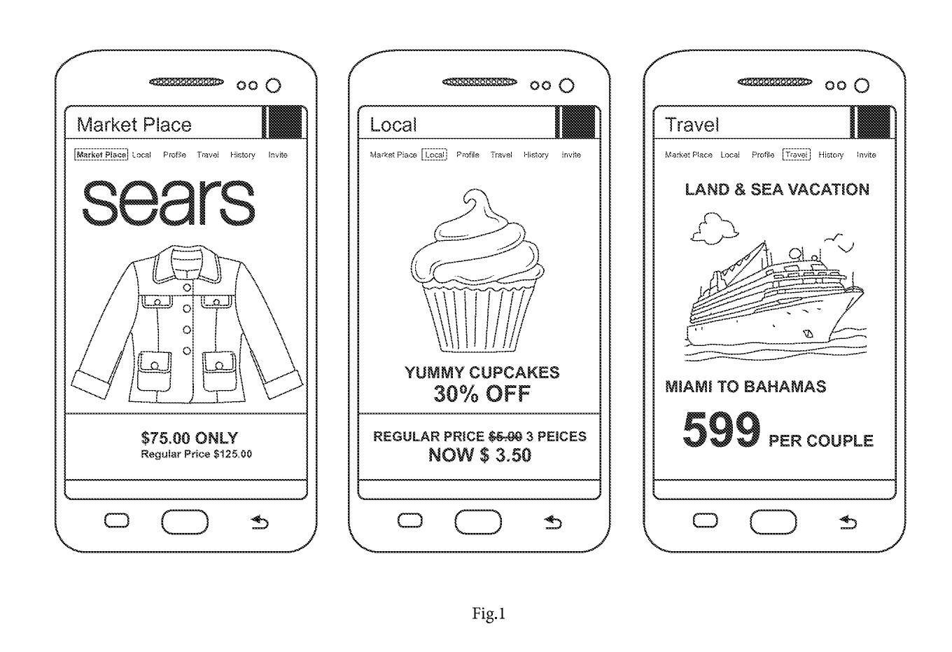

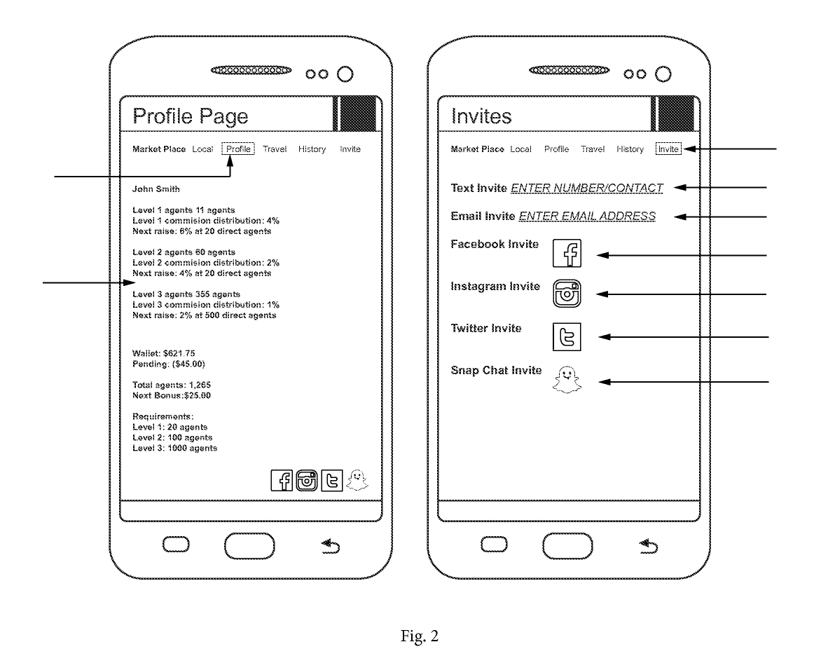

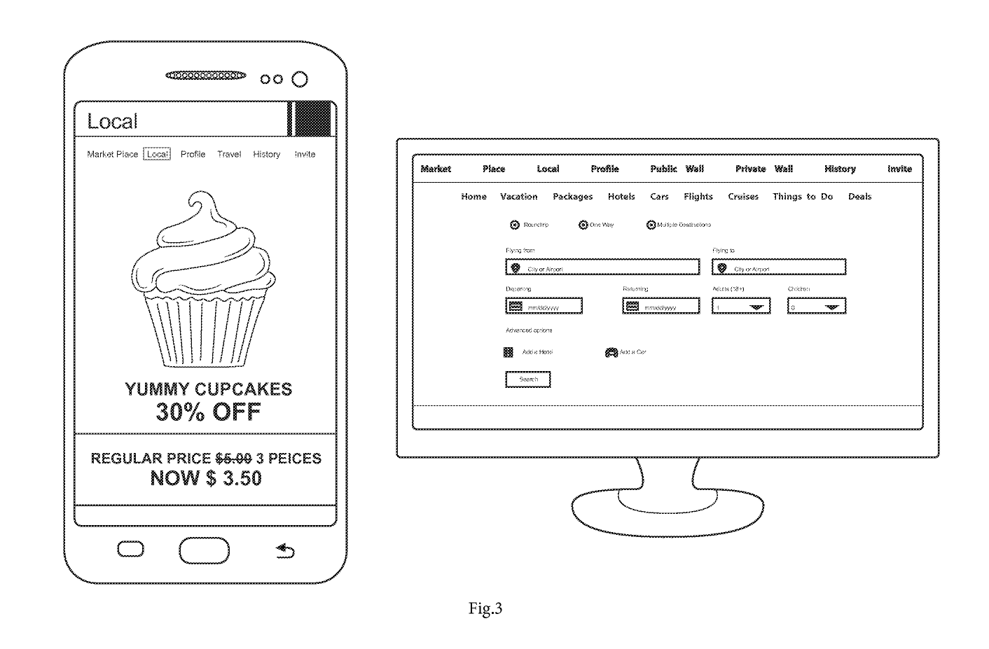

Referring to the drawings, FIG. 1 shows various interfaces of the Graphical User Interface (GUI) 3 with a plurality of option to be selected by a user. In a preferred embodiment the GUI provides a functionality to provide a user to acquire various items like clothes, edibles, travel destination and like, these items are displayed to a user with their attributes like size of the cloth, cost of the article or item or the amount of discount offered on it etc. on the display 2 of the device 1. Further FIG. 2 shows an interface 3 displaying the profile to a user with the various details of their profile, a user is also provide with means to invite users from various social networking environment, the inviting of the various users include a providing the an email address of the invited user and a text message. FIG. 3 shows an interface 3 displaying on handheld mobile devices 1 and on a computer device 1 with the user interface 3.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed:

1. A method for facilitating promotion of personal or commercial travel itinerary using social computing based environment, wherein a central server is connected to a plurality of user devices over a network, method comprising:
receiving, using one or more computing devices, information about the travel itinerary of at least one user, wherein the information comprises a name, at least one travel destination, and a travel plan of the user;
providing, through a social computing based means, a means to a user to create a user account, wherein the user account enables the user to access the social computing based means;
registering at least one user profile by receiving in a database of the central server, with the information provided by the new user at the server;
generating at least one user profile for the registered user of the social computing based network, in connection with the user registration;
providing, through the social computing based means, a means to the user to provide information associated with the user, communicate and interact with other users having accounts associated with the social computing based means;
providing, through the social computing based means, a means to the user to add at least one travel itinerary to be viewed by the other users having accounts associated with the social computing based means;
providing, through the social computing based means, a means to the user to post at least one information item relating to the travel itinerary over the social computing based network;
providing, through the social computing based means, a means to the user to link various other social networking profiles to the user profile of the social computing based network. providing, through the social computing based means, a means to the user to view at least one news item posted by the other users;
providing, through the social computing based means, a recommending mechanism means to facilitate recommendation between the user and the other users;
providing, through the social computing based means, a payment mechanism means to facilitate monetary transactions between the user and the other users; and
providing, through the social computing based means, a means to the end user for viewing information about the at least one travel itinerary recommended by the user.

2. The method according to claim 1 for facilitating promotion of personal or commercial travel itinerary using social computing based environment, wherein the user creates a travel plan using the user profile.

3. The method according to claim 1 for facilitating promotion of personal or commercial travel itinerary using social computing based environment, wherein the user may purchase a travel plan with deals.

4. The method according to claim 1 for facilitating promotion of personal or commercial travel itinerary using social computing based environment, wherein the user may post the purchase travel plan on the user profile.

5. The method according to claim 1 for facilitating promotion of personal or commercial travel itinerary using social computing based environment, wherein the user may post the purchase travel plan on the user profile of plurality of other user to suggest the same plan

6. The method according to claim 1 for facilitating promotion of personal or commercial travel itinerary using social computing based environment, wherein the user may earn commission if an end user purchases the travel plan suggested by the user.

7. The method according to claim 1 for facilitating promotion of personal or commercial travel itinerary using social computing based environment, wherein the commission earned by the user can be enables in the payment mechanism means to facilitate monetary transactions between the users and the end user
